(19) United States
(12) Patent Application Publication
(10) Pub. No.: US 2008/0040193 A1
(43) Pub. Date: Feb. 14, 2008

(54) System and method for dynamic staff bidding

(76) Inventor: Kenneth W. Dion, Austin, TX (US)

Correspondence Address: Michael T. Perkins, 902 McPhaul st, Austin, TX, 78758, US

(21) Appl. No.: 11/888,159

(22) Filed: Jul. 31, 2007

Related U.S. Application Data
(60) Provisional application No. 60/837,497, filed on Aug. 14, 2006.

(51) Int. Cl. G05B 13/00

(52) U.S. Cl. 705/9

(57) ABSTRACT

A system and method for implementing a dynamic staff bid system of scheduling and time slotting of staff personnel by administrative personnel. The present invention with the matching engine selecting qualified, capable employees by direct messaging for bidding based on dynamic feedback reduces potentially dangerous mismatches of personnel. Also the present invention affords improved work availability to employees, improved insight (from on the job feedback) enhanced flexibility to administrators and an improved working environment.

### FEDERALLY SPONSORED RESEARCH

N/A

### SEQUENCE LISTING OR PROGRAM

N/A

### BACKGROUND

1. Technical Field of Invention 705/8

This invention relates to financial resource management and more particularly to such a system and method with facilities for allocating resources and scheduling desired capabilities.

2. Background of the Invention

Administrative tasks for operational staffing on a 24/7 schedule has classically been fraught with errors; humans are not particularly good at multitasking and while scheduling when writing a name in a box is routine and perhaps boring to the individual performing the task an error can have serious consequences. There has been improvement in the tools available to administrators for scheduling of specific capabilities at specific times. Although improvements have been made, due to the unobvious complexity of scheduling individuals with specific competencies at varied times, the offerings to date have not contained sufficient functionality to satisfy the needs of both the administrators and staff. The most current published art contains functionality such as in US Patent Publication # 20070078695 titled “Methods, systems, and computer program products for identifying assets for resource allocation”, Zingelewicz et al. Apr. 5, 2007, disclose methods, systems, and computer program products for identifying assets for resource allocation are provided. The method includes gathering data that includes asset data and ambient area data. While Zingelewicz et al. may be able to identify assets for resource allocation there is no functionality for an automated software management tool for administering task schedules through intelligent matching of staff, by specific competencies and past performance, at specific times featuring dynamic schedule and bid monitoring including reporting capabilities. Additionally in US Patent Publication # 20070156494, titled “System and method for providing profile enhancement using scheduling information” Boss et al. Jul. 5, 2007, disclose a system and method of enhancing a profile of a portable device. While Boss et al. may be capable of enhancing a profile of a portable device to make messages more easily understood on a device with a reduced display capability the is no functionality to implement an automated software management tool for administering task schedules through intelligent matching of staff, by specific competencies and past performance, at specific times featuring dynamic schedule and bid monitoring including reporting capabilities.

The current tools available today are typified by U.S. Pat. No. 7,167,855 titled “Internet-based matching service for expert consultants and customers with matching of qualifications and times of availability”, Koenig, Richard, Jan. 23, 2007 discloses an Internet server matches experts offering consulting services in the biological sciences or the like with potential customers of such consulting services. While Koenig may be able to match experts and clients the structural approach (two tiered search) to the system as disclosed in the '855 patent is inappropriate to an automated software management tool for administering task schedules through intelligent matching of staff, by specific competencies and past performance, at specific times featuring dynamic schedule and bid monitoring including reporting capabilities. Another example exists in U.S. Pat. No. 7,073,126 Khandekar, Jul. 4, 2006 where a “method and system of deploying server-based applications”, allows client to interact with remote databases but has no facility for notification, selection, or awarding time/shift slots. Another approach is disclosed by U.S. Pat. No. 7,024,376 Yuen, Apr. 4, 2006 where an “Internet-based auction method” allows remote clients access to items. The method as disclosed by Yuen could not be successfully adapted to the present invention intent without prohibiting the intended function of Yuen's invention. No facility for combining the necessary functions to run a shift scheduling system are included or available with Yuen. Another approach is disclosed by U.S. Pat. No. 6,950,801 Brookes, et al. Sep. 27, 2005 where a “method and apparatus for coordinating services” provides remote servicing and scheduling to clients. Brookes methods should be fine for insurance service delivery services, however, without the necessary functionality to maintain, request, solicit, and award time/slot shifts the functionality of Brookes, et al. is not available to run a shift schedule bidding system with feedback. Another approach is disclosed by U.S. Pat. No. 6,587,831 O'Brien, Jul. 1, 2003, where a “system and method for online scheduling and shift management” proposes the basics of creating a schedule shift management system. Although many aspects of dynamically implementing and managing shift/schedule slot management the system has no facility for feeding back into the system or incorporating critical data into the shift/schedule slot determination decision. Another approach is disclosed by U.S. Pat. No. 6,523,037 Monahan, et al. where a “method and system for communicating selected search results between first and second entities over a network”, proposing improved methods of search reporting. While these functions may be important to on line item auctions they will not facilitate a time/schedule slot management capability. These systems have relied on a bulletin board type approach where open schedule shift information is “posted” for staff review and potential bidding. Systems that are available that have no obvious patent protection include the following. Vastech provides around the clock scheduling for around the clock workforce. While many features are available from Vastech no dynamic feedback or critical task information is available to users, staff, or administrative personnel. Another unprotected product is named Bidshift for managing staff slotting. While many features are available from Bidshift no dynamic feedback or critical task information is available to users, staff, or administrative personnel. Another unprotected product is named nightengale for shift schedule management. While many features are available from nightengale no dynamic feedback or critical task information is available to users, staff, or administrative personnel. Another unprotected product is smartshift by stay staffed for managing staffing of organizations. While many features are available from smartshift no dynamic feedback or critical task information is available to users, staff, or administrative personnel. Another unprotected product is from symbio solutions for managing hospital staffing. While many features are available from symbio solutions no dynamic feedback or critical task information is available to users, staff, or administrative personnel. Another unprotected product is by flexistaff for scheduling solutions. While many features are available from flexistaff no dynamic feedback or critical task information is available to users, staff, or administrative personnel. Another unprotected product is res-q for health care staffing management tools. While many features are available from res-q no additional implementation staff and consultants are required for set up; in addition no dynamic feedback or critical task information is available to users, staff, or administrative personnel. Another unprotected product available is shiftwise automated internal and agency staff management. While many features are available from shiftwise no dynamic feedback or critical task information is available to users, staff, or administrative personnel. Combining of the aforementioned functionality would not constitute a complete, functional, and usable package; such a system requires seamless operation and total reliability or it will be unusable.

What is needed is an automated software management tool for administering task schedules through intelligent matching of staff, by specific competencies and past performance, with direct messaging notification, at specific times featuring dynamic schedule and bid monitoring including reporting capabilities.

### SUMMARY OF THE INVENTION

The present invention provides a system and method for an automated software management tool for administering task schedules through intelligent matching of staff, by specific competencies and past performance, with direct messaging notification, at specific times featuring dynamic schedule and bid monitoring including reporting capabilities. Using the present system administrators can prepare and enter a slot request specify competencies and a rate (with incremental bid steps) to a server for a vacant shift slot with a bid due date. An announcement (typically posted (not the conventional posting for review and bid purposes) to the server personal virtual information page) and an email or text message is then transmitted to pre-qualified individuals within the organization. A pre-qualified individual can bid in response to the announcement for the vacant shift slot by responding to the announcement. Additionally, a qualified individual can bid down a rate by set increments (set by administrator during preparation of slot request) when desirous of a shift. Administrators can monitor bidding (by viewing relevant pages such as schedule or Manage Staffing Needs) by qualified staff and are notified when bidding closes. When a qualified bidder has “won” a bid the bidder is notified by email or text message and on their personal virtual information page (requesting administrator is also notified by email or text message and the schedule is updated). If no qualified bidder is available the administrator is notified by the above discussed methods and will follow the classical route or by opening the bidding to participating staffing agencies to fill the vacant slot, usually at a higher rate. Being ever mindful that with any system or method the devil is in the details, as without immediate follow through confusion and inconvenience will render the system and method unused. The unique pre-selection by the present system embodiments is contrasted with current systems that have relied on a bulletin board type approach where open schedule shift information is “posted” for staff review and potential bidding. The present invention with the matching engine selecting qualified, capable employees for bidding based on dynamic feedback reduces potentially dangerous mismatches of personnel. In addition to the enhanced basic functionality the present invention offers staff members through the personal virtual information page the ability to track personal schedules through a dynamic calendar and status of bids. Additionally, staff may view openings they are qualified to bid on through their personal virtual information page. Individual competencies (such as licenses, certifications, and skills) can also be viewed on their personal virtual information page. Team members, leaders, managers, and directors can view other staff members through my Staff on the personal virtual information page. Individuals can also view, maintain, and update personal information (all credential input by personnel will be verified by administration before credential input can be used as qualifications for shift bidding purposes), e-mail, text messaging address, and passwords through the personal virtual information page. Dynamic system feedback is facilitated to supervisors by incorporating preferences based on staff performance. This feedback can be used in staff selection for specific tasks, improving decision making quality and reducing known combinational problems. A Report function on the personal virtual information page facilitates selection and content of statistical and summary reports from the system data base.

The present invention affords improved work availability to employees, improved insight (from on the job feedback) enhanced flexibility to administrators and an improved working environment.

### BRIEF DESCRIPTION OF THE DRAWINGS

FIG. 1 depicts a basic dynamic staff bid system configuration.

FIG. 2 depicts posting of a dynamic staff bid schedule opening for bid.

FIG. 3 depicts the dynamic staff bid selection and posting process

FIG. 4 depicts the dynamic staff bid reporting process.

FIG. 5 depicts the dynamic staff bid overall operational process.

FIG. 6 displays a screen shot of a dynamic staff bid interface screen.

### DETAILED DESCRIPTION OF THE DRAWINGS

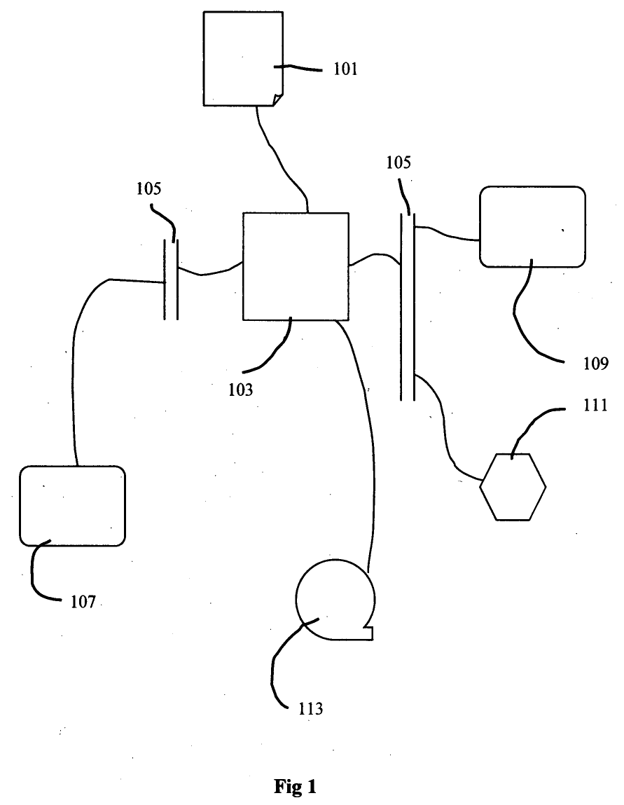

FIG. 1 depicts a basic dynamic staff bid system configuration. An administrative master schedule 101 is shown at the top of the drawing. The master schedule 101 is the dynamic schedule tool with slots for establishing personal for staffing of all shifts. The master schedule 101 is shown connected to a server 103. The server 103 is the heart of dynamic staff bid system providing computer host functions and interface to networks. The server 103 has a database 113 connected. The database 113 is the main repository for records, competencies (licenses, certifications, skills, and rates), scheduling records, and requirements. The server 103 has a network connection 105 shown to left and right respectively. The network connection 105 in this case can be any inter or intranet connection for system implementation and connectivity. The network connection 105 can be hard-line or wireless or similar means to establish connectivity. Dynamic staff bid will function equally well with any method of connectivity to implement an electronic communication system for organizational shift scheduling. The left most portion depicts a scheduling input/output terminal 107. The terminal 107 is shown for explanatory purposes as the administrative entry device where administrative personal can enter data and monitor status. The terminal 107 is typically in an administrative area. All administrative and employee staff functions can be performed from terminal 107. Additionally, with administrative identification (ID) and password entry administrative staff can perform the same functions from any terminal that supports HTML that can access the server 103. A remote input/output terminal 109 is shown connected to network 105. Terminal 109 is typically available in a staff area for employee access to schedule, bidding, and monitoring. All typical employee staff functions can be supported from terminal 109. Additionally, with employee staff ID and password entry any staff can perform the same functions from any terminal that supports HTML that can access the server 103. A mobile terminal 111 is shown for discussion and is connected to network 105. The terminal 111 is capable of direct connection to network 105 or wireless connection. The terminal 111 is shown connected on employee staff portion of drawing, however, user (administrative or employee) ID and password determine access to information and capabilities. The mobile terminal 111 is HTML compatible and capable of all functions that are supported by dynamic staff bid and individual device functionality.

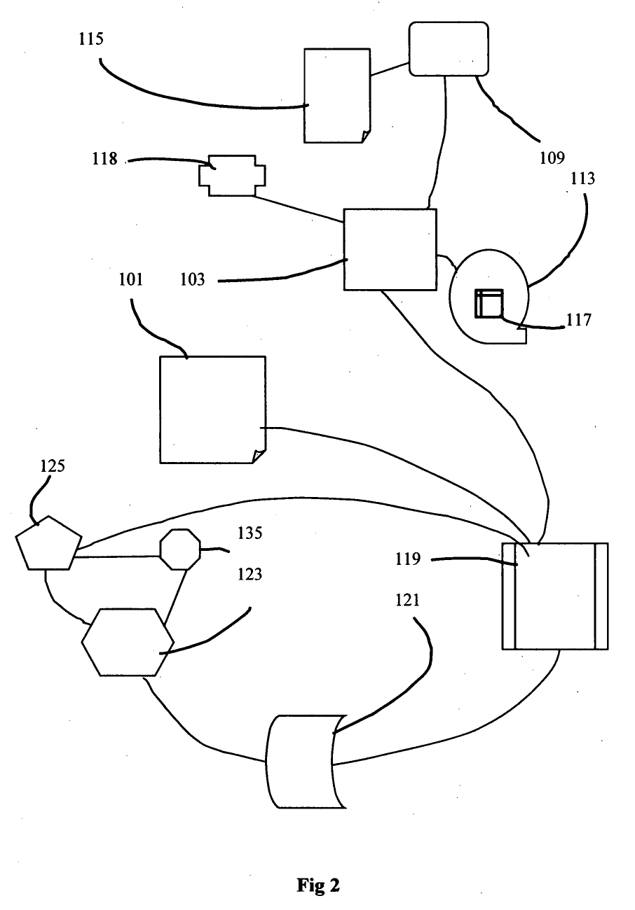

FIG. 2 depicts posting of a dynamic staff bid schedule opening for bid. In this drawing an administrative staff member submits an entry 115 to post a schedule time slot need through terminal 109 to server 103 (any HTML terminal capable of connecting to server 103 with ID and password). Typically entry 115 will contain a request for a specific shift, at a specific time with parameters with specific competencies including; licenses, certifications, skills, and a rate of remuneration (with specified amount increments for competitive bidding situations). Recurring shift requirements can be specified to repeat; for example daily, weekly, or bimonthly through a simple parameter selection. This “automated” requirements capability with the terminal entry functionality allows users to manage shift requirements that change but still require basic staff functionality. With an entry 115 server 103 accesses database 113 that contains a collection of qualified employee records 117. The records 117 are a repository of staff records, experiences, history, performance, competencies (including; licenses, certifications, skills). The server 103 also has a server mail client 118 that is a software notification engine providing routines to send messages (with direct messaging notification) to administrative and staff employees or contract workers. Typical message notifications would include a request for bid, notice of selection for a shift slot, and request for additional information. Following posting of entry 115 server 103 will employ a software sort engine 119. The sort engine 119 will match qualified staff employees (and/or contractors) from records 117 to attributes requested in entry 115. A candidate list 121 will be generated by engine 119 and candidates notified via e-mail; a list of open shifts that the candidate qualifies for are posted (will be viewable on pre-qualified staff on their personal virtual information page) for viewing on any dynamic staff bid terminal and sent in the form of a request for bid 123 to selected candidate staff 135 by the client 118. These posted lists are also available for management viewing and reporting. Responses to posting or mailing may be submitted by selected staff on any terminal through entry of their ID and password with the response. A typical response bid 125 is accepted or rejected in server 103 by a software engine; accepted bid 125 will be entered in appropriate slot on the master schedule 101.

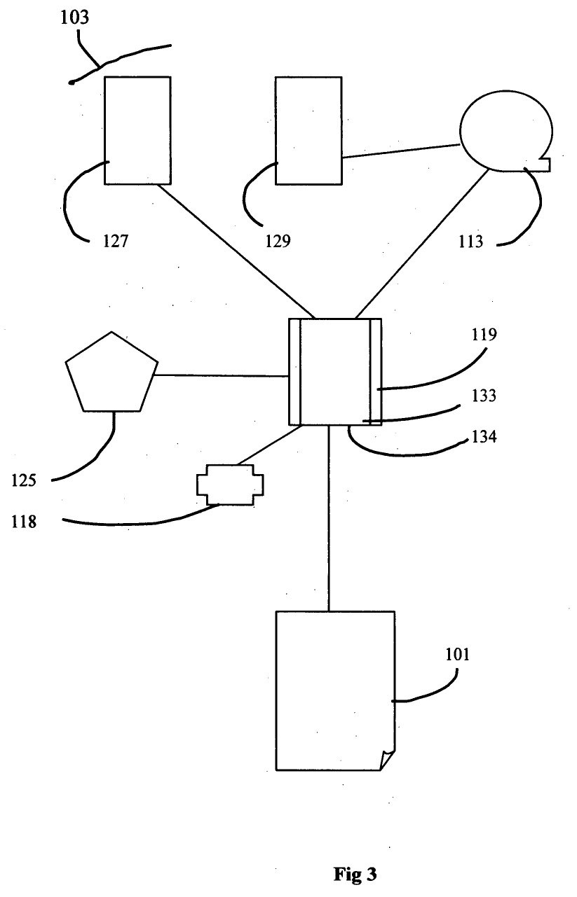

FIG. 3 depicts the dynamic staff bid selection process. All processes and functions discussed in this drawing (FIG. 3) are contained or entered into server 103. A time/shift slot record 127 apportionment is performed by administrative staff and entered into engine 119 through a terminal as discussed in FIG. 1. Returning to FIG. 3 a rate record 129 is contained in database 113. Information contained in database 113 is available to engine 119 for operations and updating. The bid 125 is available to engine 119 when submitted by staff. Additionally, engine 119 has a selection processing engine 133. The engine 133 will match and order bids from qualified staff including dynamic feedback with requested time slots. The bid 125 matched by engine 133 with record 127 will be issued by the following processes; a successful bid 125 will be notified by mail client 118, an unsuccessful bid 125 will receive an out bid message from client 118, engine 133 will retain multiple bids and facilitate multiple iterations (competing bids) of staff competition until bidding is closed by time limits set by administration, also a report engine 134 will generate shift report, update master schedule 101, and generate statistical reports. When schedule 101 is updated all affected appropriate pages (schedule, report, and home pages) will be updated for staff and administration notification.

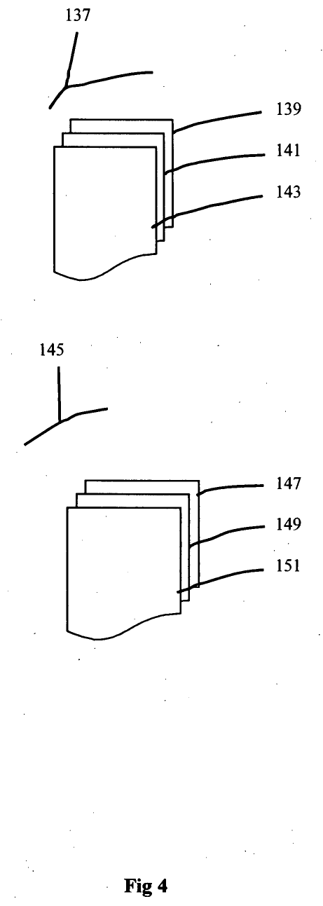

FIG. 4 depicts the dynamic staff bid reporting process. An overall system report 137 generated by engine 119 as discussed in FIG. 3 is depicted. Returning to FIG. 4 the report 137 is shown consisting of multiple reports. A summary report 139 is shown. Typically report 139 would contain statistical metrics as desired by administrators. An additional trends report 141 is shown. Typically report 141 would contain data and graphs for summarizing and forecasting statistical patterns of scheduling and performance. An additional percentages report 143 is shown. Typically report 143 would contain statistical information for identifying perturbations in system performance and implementation. A second records report area is shown by supervisor/administrative report 145. The report 145 with supervisorial preference and performance information is shown consisting of multiple reports. A task performance report 147 is shown. Typically a report 147 would collect feedback on staff performance based on actual tasks. These data would be collected by supervisors, peers, clients, doctors, and appropriate administrators. Additionally a commendations report 149 is shown. Typically a report 149 will contain positive feedback of staff that exceeds the normal call of duty. Additionally a problems report 151 is shown. Typically a report 151 will contain feedback of staff where limitations, deficiencies, or such problems have been noted. The report 151 information and data will assist in precluding mismatching of staff when situational or personality differences have been noted in past experiences.

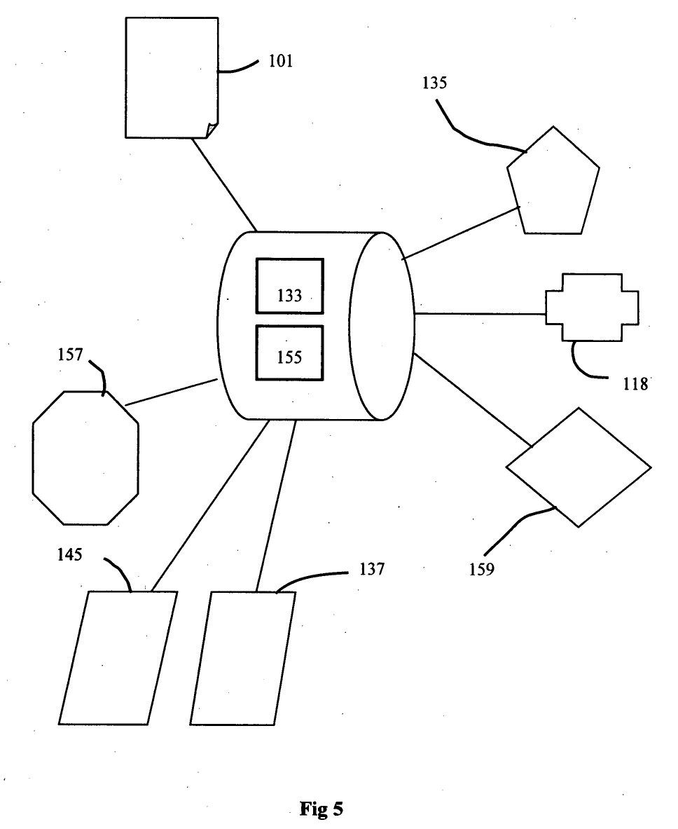

FIG. 5 depicts the dynamic staff bid overall operational process. Shown in this drawing is the selection processing engine 133 as introduced in FIG. 3. Returning to FIG. 5 an additional process is shown with engine 133 a software scheduling engine 155. The engine 155 processes matches from engine 133 and enters them into schedule 101, and mails appropriate information to staff through client 118. The engine 133 receives input form staff 135. Additionally an administrative feedback 159 including information output such as individual staff time and attendance record is provided for review. The feedback 159 time and attendance record additionally is reviewed by administration and when approved automatically submitted to payroll for staff compensation. A node for budget 157 inputs and output is provided to facilitate tracking and reporting budget considerations. A connection node to reports 137 and reports 145 is also provided for.

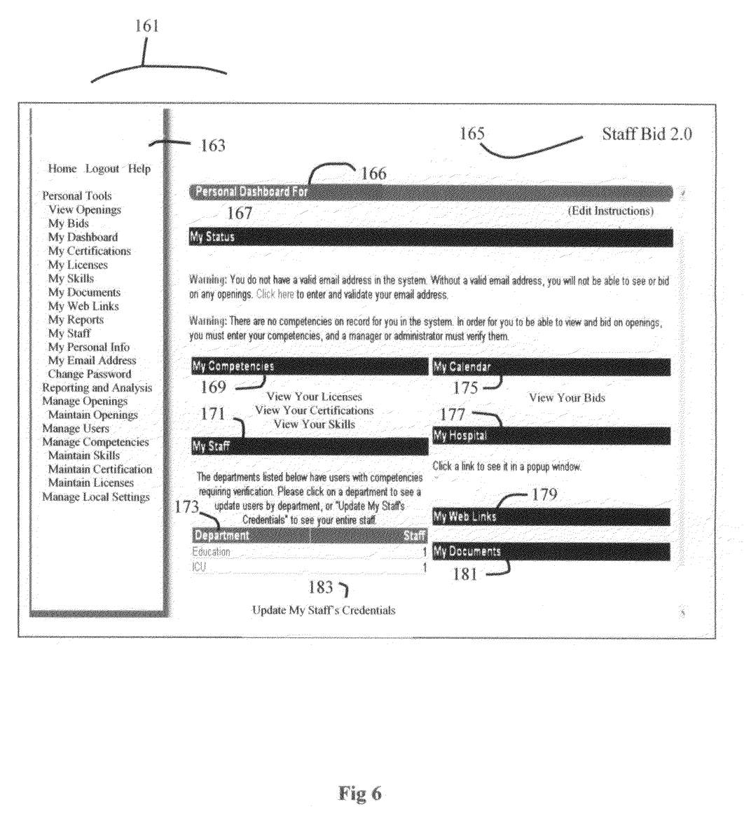

FIG. 6 displays a screen shot of a dynamic staff bid interface screen. Depicted in this drawing is a screen capture of a relevant screen of a dynamic staff bid system display 161. The display 161 features a navigation bar 163 on the left most portion. The bar 163 facilitates navigation for users to convenient and associated locations and files within the dynamic staff bid system. On the far right of the display 161 is a title bar 165 displaying Staff Bid 2.0 this screen interface page title. Directly below the bar 165 is a personal dashboard 166. The dashboard 166 is the present page, is similar to a personal homepage (or a personal virtual information page), and is supported by server 103 as shown in FIG. 1. Returning to FIG. 6, below dashboard 166 is status bar 167. The bar 167 is the area of display 161 for viewing and interacting with immediate alerts and upcoming operational necessities. To the right above bar 167 is an area 201 titled (Edit Instructions). The area 201 can be used by administrators to modify presentation and format during page set up. Also shown on display 161 is my competencies area 169. The area 169 is the area of display 161 for viewing and interacting with licenses, certifications, and skills. The area 169 is particularly for monitoring, updating status, inputting requirements, and corrections to licenses, certifications, and skills. Also shown on display 161 is my staff area 171. The area 171 is the area of display 161 for administrative reviewing of competencies requiring verification associated with present staff member. Also shown on display 161 is department area 173. The area 173 is the area of display 161 for viewing and interacting with current departmental status, notices, and requirements. Also shown on display 161 is my calendar area 175. The area 175 is the area of display 161 for viewing and interacting with committed and available schedule time slots and upcoming events. Also shown on display 161 is my hospital area 177. The area 177 is the area of display 161 for viewing and interacting with current my hospital organizational events, status, and alerts. Also shown on display 161 is my web links area 179. The area 179 is the area of display 161 for viewing and interacting with favorite or frequently used web links. Also shown on display 161 is my documents area 181. The area 181 is the area of display 161 for viewing and interacting personal and professional documents for reference and reviewing. An update hot spot 183 is provided at the bottom of display 161. The hot spot 183 would be activated when an administrator desires to view a list of their entire staff credentials and status for actions such as an verify, update, or correction to their respective licenses, certifications, and skills

### Operation

Dynamic staff bid can be implemented with a configuration as discussed in FIG. 1. An administrator would log on to terminal 107 with proper ID and password. Following acceptance of a correctly entered proper ID and password the administrator will view a screen such as presented in FIG. 6. Moving to FIG. 2 a need entry 115 would be entered by administrator. Specifics of bid increments and special requirements are now to be set by the administrator. When the administrator has selected the options desired to satisfy the shift schedule requirements selecting the submit button will upload the entered information to the system through server 103 Software selection engine 119 culls a list of eligible qualified candidates (staff 135). Server 103 has mail client 118 notify eligible staff of shift slot availability. Server 103 also posts shift slot availability on appropriate screen 161, FIG. 6. The staff 135 can submit bids to bid 125. Bid 125 will input bids to selection processing engine 133 FIG. 3. Engine 133 will transfer selections to report engine 134 for notification by mail client 118 and master schedule 101 inclusions.

### DESCRIPTION OF THE PREFERRED EMBODIMENT(S)

The preferred embodiment of dynamic staff bid is basically depicted in FIG. 1 with a computer screen interface shown as in FIG. 6. Returning to FIG. 1 at the most basic level dynamic staff bid has a master schedule 101 that is maintained and updated by server 103 with database 113. Network connections to internal and external connections should be provided. Proven security measures firewalls, network monitors, and constant reviews of potential compromises with identification and password protection are required for reliable operation of dynamic staff bid. Access from such as terminals 107, 109, and 111 will facilitate an automated software management tool for administering task schedules through intelligent matching of staff, by specific competencies and past performance, at specific times featuring dynamic schedule and bid monitoring including reporting capabilities. As described in the previous text what is disclosed is an efficient, flexible, and effective request, time slot schedule bid selection, notification system that through proper use can improve organizational operation.

What is claimed is:

1. A system for dynamic staff allocation for shift assignment by bidding consisting of:
server means for storing a data base of staff competencies,
server means for storing a data base of staff experiences,
server means for storing a data base of supervisorial preferences,
input terminal means for interfacing to the server with data bases of staff competencies, experiences, and supervisorial preferences,
administrative entry means for establishing administrative master schedule containing organization time and rate requirements with staff competencies,
experiences, and supervisorial preferences,
processing means for matching administrative schedule requirements and staff competencies, experiences, and supervisorial preferences,
sending means for directly notifying qualified staff of openings available for bidding, requesting bids from matched staff members,
input means for qualified staff to submit a bid for scheduling their competencies and experience for a shift in response to the process notification,
processing means for selecting qualified staff is accomplished by a collection of predetermined administrative criteria from the qualified presently matched staff,
processing means for notifying the qualified staff of a shift schedule success resulting in an award of a shift for a given rate, at a specified time,
posting means of notice of award to a qualified staff of a shift for a given rate, at a specified time on a master schedule, and
processing means for generating administrative reports for system feedback and improvement.

2. The dynamic staff allocation system for shift assignment of claim 1 wherein staff competencies in the data base are determined by individual licenses, individual certifications, and individual skills.

3. The dynamic staff allocation system for shift assignment of claim 1 wherein staff experiences in the data base are determined by previous supervisor input, recent, and current task performance.

4. The dynamic staff allocation system for shift assignment of claim 1 wherein multiple pre-qualified staff may bid competitively for the same schedule time slot at administrative specified increments.

5. The dynamic staff allocation system for shift assignment of claim 1 wherein supervisorial preferences and performance in data base are determined by specific supervisorial input, or input from human resources system.

6. The dynamic staff allocation system for shift assignment of claim 1 wherein an input means can be any terminal capable of hosting a HTML browser with a network connection and the correct user identification and password.

7. The dynamic staff allocation system for shift assignment of claim 1 wherein a processing means for matching schedule openings for staff, created by administrative staff, with qualified staff based on staff competencies, experiences, and supervisorial preferences is accomplished by a software engine.

8. The dynamic staff allocation system for shift assignment of claim 1 wherein a processing means for notifying qualified staff of shift schedule availability and timing information consists of a software notification engine with posting to relevant pages, direct email, and text messaging functionality.

9. The dynamic staff allocation system for shift assignment of claim 1 wherein a processing means for directly notifying qualified staff of shift schedule availability and timing information consists of a software notification engine with simultaneous network scheduling posting.

10. The dynamic staff allocation system for shift assignment of claim 1 wherein an input means for qualified staff to submit a bid for scheduling their competencies and experience for a shift in response to the process notification is any terminal capable of HTML browser and a network connection.

11. The dynamic staff allocation system for shift assignment of claim 1 wherein a processing means for selecting qualified staff is accomplished by a collection of predetermined administrative criteria from the qualified presently matched staff.

12. The dynamic staff allocation system for shift assignment of claim 1 wherein a processing means for notifying the qualified staff of a shift schedule bid success resulting in an award of a shift for a given rate, at a specified time is a server mail client.

13. The dynamic staff allocation system for shift assignment of claim 1 wherein a processing means for notifying the qualified staff of a shift schedule bid success resulting in an award of a shift for a given rate, at a specified time is posted on master schedule.

14. The dynamic staff allocation system for shift assignment of claim 1 wherein a processing means for generating administrative reports for system feedback and improvement is a software report generator.

15. A computerized method for implementing a dynamic staff allocation for shift assignment through bidding function comprising:
storing staff competencies; [licenses, certifications, skills];
storing staff experience;
storing supervisorial feedback on employee performance;
storing staff supervisorial preferences;
specifying an amount increment for competitive bidding situations;
requesting staff competencies for a specific time slot at a specific rate;
identifying staff competencies from sort/matching to requesting above;
requesting from identified staff bids to fill a specific time slot at a specific rate;
receiving bids from above identified staff;
selecting from bids received above choice for slot;
notifying selected staff bid from above;
reporting summaries and statistical information; and
posting on master schedule award of time slot qualified staff.

16. The computerized method for implementing a dynamic staff allocation for shift assignment of claim 15 staff competencies further comprising; individual licenses, certifications, and skills.

17. The computerized method for implementing a dynamic staff allocation for shift assignment of claim 15 staff competencies further comprising; administrative pre-selected of the amount increment for competitive bidding situations.

18. The computerized method for implementing a dynamic staff allocation for shift assignment of claim 15 staff experiences further comprising; individual actual task performance.

19. The computerized method for implementing a dynamic staff allocation for shift assignment of claim 15 supervisorial preferences further comprising; qualitative reports of individual performance subsequent to task performance.

20. The computerized method for implementing a dynamic staff allocation for shift assignment of claim 15 requesting staff competencies for a specific time slot at a specific rate further comprising; assigning competencies to a specific time slot.

21. The computerized method for implementing a dynamic staff allocation for shift assignment of claim 15 identifying staff competencies from sort/matching further comprising; iterative selection process.

22. The computerized method for implementing a dynamic staff allocation for shift assignment of claim 15 requesting from identified staff bids to fill a specific time slot at a specific rate further comprising; notifying staff by message and posting.

23. The computerized method for implementing a dynamic staff allocation for shift assignment of claim 15 receiving bids from above identified staff further comprising; storing and sorting received bids.

24. The computerized method for implementing a dynamic staff allocation for shift assignment of claim 15 selecting from bids received above choice for slot further comprising; prioritizing and selecting best choice for shift assignment.

25. The computerized method for implementing a dynamic staff allocation for shift assignment of claim 15 notifying selected staff bid from above further comprising; staff notification by email, text messaging, and posting to appropriate pages.

26. The computerized method for implementing a dynamic staff allocation for shift assignment of claim 15 reporting summaries and statistical information further comprising; individual specific reports based on requirements.

27. The computerized method for implementing a dynamic staff allocation for shift assignment of claim 15 posting on master schedule award of time slot qualified staff further comprising; system wide schedule availability.

28. A virtual server based dynamic system for creation, operation, and maintenance of organizational time slot scheduling with specified criteria including competencies, experience, supervisorial preferences, time slot, and rates.
